(19) United States
(12) Patent Application Publication
(10) Pub. No.: US 2016/0307296 A1
(43) Pub. Date: Oct. 20, 2016

(54) IMAGE ZOOMING METHOD AND TERMINAL DEVICE

(71) Applicant: Huawei Technologies Co., Ltd., Shenzhen (CN)

(72) Inventor: Wenxu Lin, Shenzhen (CN)

(21) Appl. No.: 15/196,760

(22) Filed: Jun. 29, 2016

Related U.S. Application Data
(63) Continuation of application No. PCT/CN2014/094828, filed on Dec. 24, 2014.

(30) Foreign Application Priority Data
Dec. 30, 2013 (CN) 201310746703.4

(51) Int. Cl. G06T 3/40; G06F 3/01

(52) U.S. Cl. CPC G06T 3/40; G06F 3/017

(57) ABSTRACT

The present invention relates to the field of image processing technologies. Embodiments of the present invention provide an image zooming method and a terminal device, where the method includes: acquiring a displacement ΔS that a terminal device moves relative to a holder of the terminal device; acquiring a time ΔT consumed when the terminal device moves the displacement ΔS; determining a zoom ratio of the terminal device according to the displacement ΔS and the time ΔT; and zooming, according to the zoom ratio, an image displayed on a display screen of the terminal device.

### CROSS-REFERENCE TO RELATED APPLICATIONS

This application is a continuation of International Application No. PCT/CN2014/094828, filed on Dec. 24, 2014, which claims priority to Chinese Patent Application No. 201310746703.4, filed on Dec. 30, 2013, both of which are hereby incorporated by reference in their entireties.

### TECHNICAL FIELD

The present invention relates to the field of image processing and display technologies, and in particular, to an image zooming method and a terminal device.

### BACKGROUND

Terminal devices become increasingly popular in people's lives and work. When an existing terminal device implements a function of zooming an image displayed on its display screen, a holder of the terminal device generally needs to keep the terminal device steady with one hand, and then drag on the screen of the terminal device or press a key located on the terminal device with the other hand, so as to implement zooming of the image displayed on the display screen of the terminal device. This zooming method has problems of inconvenient operation and poor user experience.

### SUMMARY

An objective of embodiments of the present invention is to provide an image zooming method and a terminal device, so as to improve operation convenience, and further improve user experience.

According to a first aspect, an embodiment of the present invention provides an image zooming method, where the method includes: acquiring displacement ΔS that a terminal device moves relative to a holder of the terminal device; acquiring time ΔT consumed when the terminal device moves the displacement ΔS; determining a zoom ratio of the terminal device according to the displacement ΔS and the time ΔT; and zooming, according to the zoom ratio, an image displayed on a display screen of the terminal device.

With reference to the first aspect, in a first implementation manner, the acquiring displacement ΔS that a terminal device moves relative to a holder of the terminal device includes: acquiring a distance S1 of the terminal device relative to the holder of the terminal device; acquiring a distance S2 of the terminal device relative to the holder of the terminal device, where the distance S2 is different from the distance S1; and acquiring, according to the distance S1 and the distance S2, the displacement ΔS of the terminal device relative to the holder of the terminal device.

With reference to the first implementation manner of the first aspect, in a second implementation manner, the acquiring time ΔT consumed when the terminal device moves the displacement ΔS includes: recording a moment T1 at which the terminal device acquires the distance S1; recording a moment T2 at which the terminal device acquires the distance S2; and acquiring, according to the moment T1 and the moment T2, the time ΔT consumed when the terminal device moves the displacement ΔS.

With reference to the first aspect, the first implementation manner of the first aspect, or the second implementation manner of the first aspect, in a third implementation manner, the determining a zoom ratio of the terminal device according to the displacement ΔS and the time ΔT includes: calculating a movement speed of the terminal device according to the displacement ΔS and the time ΔT; and determining the zoom ratio of the terminal device according to the movement speed.

With reference to the first aspect, or any one of the first implementation manner of the first aspect to the third implementation manner of the first aspect, in a fourth implementation manner, the method further includes: when the displacement ΔS is zero and time of maintaining a state that the displacement ΔS is zero is greater than or equal to a time threshold, stopping zooming in a case in which the zoom ratio is maintained.

With reference to the fourth implementation manner of the first aspect, in a fifth implementation manner, when or after the stopping zooming in the case in which the zoom ratio is maintained, the method further includes: storing the zoom ratio.

With reference to the first aspect, or any one of the first implementation manner of the first aspect to the fifth implementation manner of the first aspect, in a sixth implementation manner, the method further includes: disabling a zooming function of the terminal device when the displacement ΔS is greater than or equal to a maximum distance threshold Smax; or disabling a zooming function of the terminal device when the zoom ratio is equal to a maximum zoom ratio threshold.

According to a second aspect, an embodiment of the present invention further provides a terminal device, where the terminal device includes: a distance acquiring unit, configured to acquire displacement ΔS that a terminal device moves relative to a holder of the terminal device; a time acquiring unit, configured to acquire time ΔT consumed when the terminal device moves the displacement ΔS; a determining unit, connected to the distance acquiring unit and the time acquiring unit, and configured to determine a zoom ratio of the terminal device according to the displacement ΔS and the time ΔT; and a zooming unit, connected to the determining unit, and configured to zoom, according to the zoom ratio, an image displayed on a display screen of the terminal device.

With reference to the second aspect, in a first implementation manner, the distance acquiring unit is specifically configured to: acquire a distance S1 of the terminal device relative to the holder of the terminal device; move the terminal device and acquire a distance S2 of the terminal device relative to the holder of the terminal device, where the distance S2 is different from the distance S1; and acquire, according to the distance S1 and the distance S2, the displacement ΔS of the terminal device relative to the holder o terminal device.

With reference to the first implementation manner of the second aspect, in a second implementation manner, the time acquiring unit is specifically configured to: record a moment T1 at which the terminal device acquires the distance S1; record a moment T2 at which the terminal device acquires the distance S2; and acquire, according to the moment T1 and the moment T2, the time ΔT consumed when the terminal device moves the displacement ΔS.

With reference to the second aspect, the first implementation manner of the second aspect, or the second implementation manner of the second aspect, in a third implementation manner, the determining unit is specifically configured to: calculate a movement speed of the terminal device according to the displacement ΔS and the time ΔT; and determine the zoom ratio of the terminal device according to the movement speed.

With reference to the second aspect, or any one of the first implementation manner of the second aspect to the third implementation manner of the second aspect, in a fourth implementation manner, the terminal device further includes a zooming control unit, where the zooming control unit is configured to: when the displacement ΔS is zero and time of maintaining a state that the displacement ΔS is zero is greater than or equal to a time threshold, stop zooming in a case in which the zoom ratio is maintained.

With reference to the fourth implementation manner of the second aspect, in a fifth implementation manner, the terminal device further includes a storage unit, where the storage unit is configured to store the zoom ratio when or after the zooming control unit stops zooming in the case in which the zoom ratio is maintained.

With reference to the fourth implementation manner of the second aspect or the fifth implementation manner of the second aspect, in a sixth implementation manner, the zooming control unit is further configured to disable a zooming function of the terminal device when the displacement ΔS is greater than or equal to a maximum distance threshold Smax; or disable a zooming function of the terminal device when the zoom ratio is equal to a maximum zoom ratio threshold.

It can be learned that according to the image processing method and the terminal device provided in the embodiments of the present invention, by acquiring displacement ΔS that the terminal device moves relative to a holder of the terminal device, and time ΔT consumed when the terminal device moves the displacement ΔS, a zoom ratio of the terminal device may be determined, so that the zoom ratio may be used to perform zooming processing on an image displayed on a display screen of the terminal device. When the technical solutions provided in the embodiments of the present invention are used to perform image zooming processing, for the holder of the terminal device, zooming of the image displayed on the terminal device can be implemented by changing a relative distance between the terminal device and the holder of the terminal device; therefore, the zooming processing on the image displayed on the terminal device is performed more conveniently, thereby improving operation convenience, and further improving user experience.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic structural diagram of a terminal device;

FIG. 2a is a schematic method flowchart of an image zooming method according to an embodiment of the present invention;

FIG. 2b is a schematic method flowchart of another image zooming method according to an embodiment of the present invention;

FIG. 3a is a schematic diagram of a structure of a terminal device according to an embodiment of the present invention;

FIG. 3b is a schematic diagram of a structure of another terminal device according to an embodiment of the present invention; and

FIG. 4 is a schematic diagram of a structure of a terminal device according to an embodiment of the present invention.

### DETAILED DESCRIPTION

The following clearly describes the technical solutions in the embodiments of the present invention with reference to the accompanying drawings in the embodiments of the present invention Apparently, the described embodiments are merely some but not all of the embodiments of the present invention. All other embodiments obtained by a person of ordinary skill in the art based on the embodiments of the present invention without creative efforts shall fall within the protection scope of the present invention.

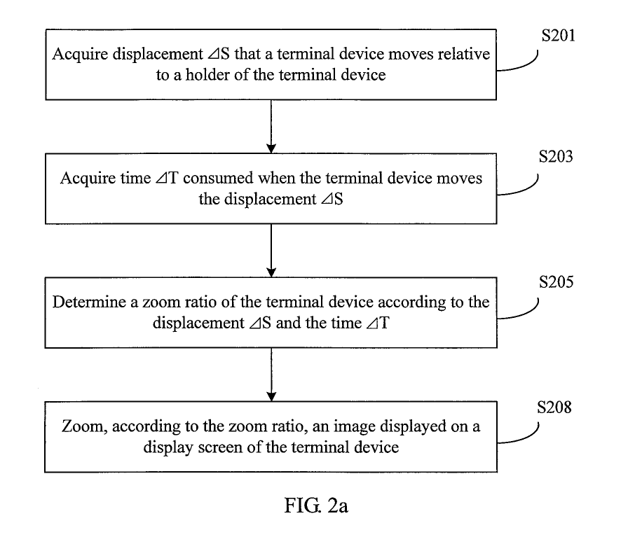

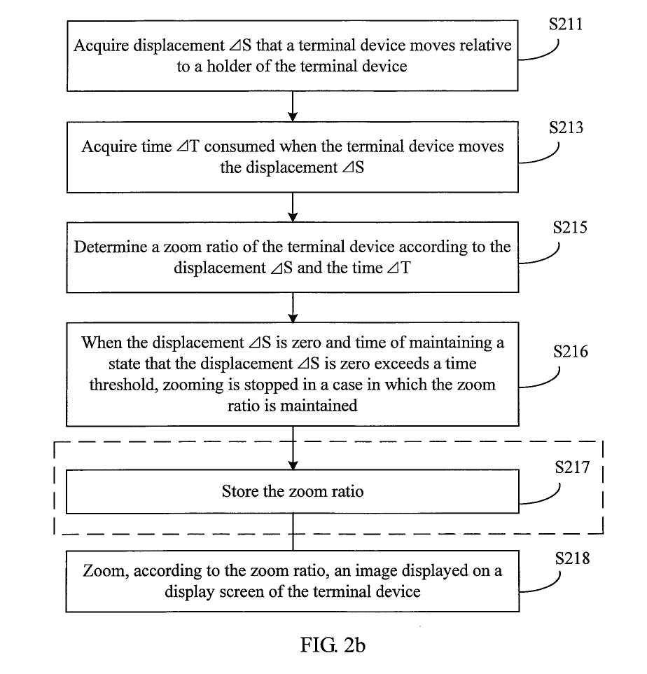

Referring to FIG. 2a, FIG. 2a is a schematic method flowchart of an image zooming method according to an embodiment of the present invention. The image zooming method provided in this embodiment of the present invention may be applied to a computer system, where the computer system may be located on a physical host, or may be distributively located on multiple physical hosts. Specifically, the computer system may be located on one or more terminals of various types, such as computers, portable computers, handheld devices (such as a mobile phone and a PAD), and servers.

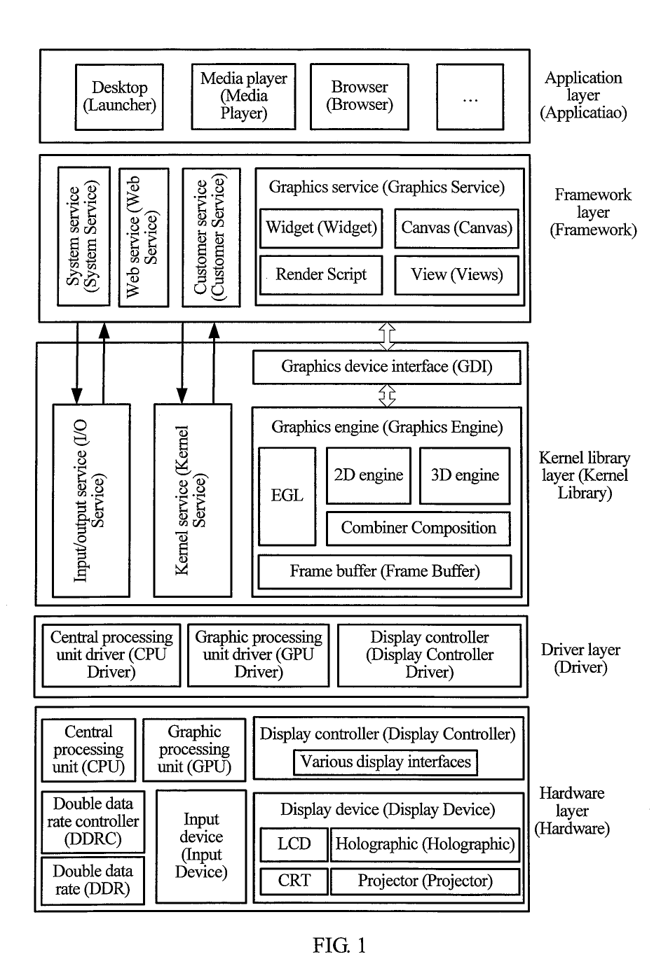

FIG. 1 is used as an example to describe a logical structure of a computing node to which the image zooming method provided in this embodiment of the present invention is applied. The computing node may be a terminal device, and the terminal device may be specifically a smartphone. As shown in FIG. 1, a hardware layer of the terminal device includes a CPU, a GPU, and the like. Certainly, the hardware layer of the terminal device may further include a storage device, an input/output device, a memory, a memory controller, a network interface, and the like, where the input device may include a keyboard, a mouse, a touchscreen, and the like, and the output device may include a display device, such as an LCD, a CRT, a holographic imaging device (Holographic), a projector (Projector), and the like. An operating system (such as Android) and some application programs may run at the hardware layer. A kernel library is a core part of the operating system, and includes an input/output service, a kernel service, a graphics device interface, a graphics engine (Graphics Engine) that implements graphics processing of the CPU and the GPU, and the like. The graphics engine may include a 2D engine, a 3D engine, a combiner (Composition), a frame buffer (Frame Buffer), an EGL, and the like. In addition, the terminal further includes a driver layer, a framework layer, and an application layer. The driver layer may include a CPU driver, a GPU driver, a display controller driver, and the like. The framework layer may include a graphic service (Graphic Service), a system service (System service), a web service (Web Service), a customer service (Customer Service), and the like. The graphic service may include a widget (Widget), a canvas (Canvas), a view (Views), Render Script, and the like. The application layer may include a desktop (launcher), a media player (Media Player), a browser (Browser), and the like.

FIG. 1 is used as an example. The image zooming method provided in this embodiment of the present invention is applied to a computing node, and the computing node may be a terminal device, where a hardware layer of the terminal device may include hardware such as a processor, (for example, a central processing unit (Center Processing Unit, CPU), a graphic processing unit (Graphic Processing Unit, GPU)), a display controller (Display Controller), a memory, a memory controller, an input device, and a display device. A kernel library (Kernel Library) layer may include an input/output service (I/O Service), a kernel service (Kernel Service), and a graphic engine (Graphic Engine). It should be understood that for a logical structure of an execution entity of the method in this embodiment of the present invention, reference may be made to FIG. 1.

As shown in FIG. 2a, the image zooming method provided in this embodiment of the present invention includes the following steps:

S201. Acquire displacement ΔS that a terminal device moves relative to a holder of the terminal device.

S203. Acquire time ΔT consumed when the terminal device moves the displacement ΔS.

It should be noted that it is a specific application that implements a zooming function of the terminal device. After being triggered, the application becomes a process that runs in an operating system. Specifically, the application may run when the terminal device is powered on, or the holder of the terminal device may need to start the application, for example, by tapping a user interface of the application displayed on a display screen of the terminal device or by pressing a key that is used to start the application and that is located on the terminal device.

Specifically, after the application that is used to implement the zooming function of the terminal device and that is on the terminal device is started, the application invokes, at a fixed time interval such as 0.5 s, a device having a distance acquiring function, such as an infrared sensor located on the terminal device, to acquire a distance of the terminal device relative to the holder of the terminal device. For example, at a moment T1, a distance that is of the terminal device relative to the holder of the terminal device and that is acquired by the infrared sensor is S1, and the application synchronously records the moment T1 at which the infrared sensor acquires the distance S1, and saves the distance S1 and the moment T1. Correspondingly, at a moment T2, a distance that is of the terminal device relative to the holder of the terminal device and that is acquired by the infrared sensor is S2. It should be noted that the distance S1 is different from the distance S2. The application synchronously records the moment T2 at which the infrared sensor acquires the distance S2, and saves the distance S2 and the moment T2. Then the application acquires, according to the distance S1 and the distance S2, the displacement ΔS of the terminal device relative to the holder of the terminal device; and acquires, according to moment T1 and the moment T2, the time ΔT consumed when the terminal device moves the displacement ΔS relative to the holder of the terminal device.

It should be noted that the fixed time interval is preset. A smaller value that is set for the fixed time interval indicates higher sensitivity of zooming of an image displayed on the terminal device, and correspondingly, indicates a larger data volume that needs to be calculated by the terminal device, and a stronger processing capability required by the terminal device. Therefore, during presetting of the fixed time interval, zooming sensitivity, a data calculation amount, and other related factors need to be comprehensively considered to set an appropriate time interval.

S205. Determine a zoom ratio of the terminal device according to the displacement ΔS and the time ΔT.

Specifically, the determining a zoom ratio of the terminal device according to the displacement ΔS and the time ΔT includes: calculating a movement speed of the terminal device according to the displacement ΔS and the time ΔT, and determining the zoom ratio of the terminal device according to the movement speed.

S208. Zoom, according to the zoom ratio, an image displayed on a display screen of the terminal device.

As another embodiment of the present invention, referring to an image zooming method described in FIG. 2b, the image zooming method includes step S216 in which when the displacement ΔS is zero and time of maintaining a state that the displacement ΔS is zero exceeds a time threshold, zooming is stopped in a case in which the zoom ratio is maintained.

It should be noted that, that the displacement ΔS is zero means that a distance of the terminal device relative to the holder of the terminal device remains unchanged. The time threshold is a preset time interval, which is used to determine whether to stop zooming. Specifically, when the time of maintaining the state that the displacement ΔS is zero is greater than or equal to the time threshold, zooming is stopped in the case in which the zoom ratio is maintained. It should be noted that experience of a user who uses the terminal device needs to be considered during presetting of the time threshold, and the time threshold may be 1 s, 2 s, or the like.

Further, after the zooming is stopped while the zoom ratio is maintained, the image zooming method further includes step S217 in which the zoom ratio is stored.

It should be noted that the image zooming method described in FIG. 2b further includes steps S211, S213, S215, and S218. Specific content of these steps is similar to that of the steps S201, S203, S205, and S208 in the image zooming method described in FIG. 2a. For details, reference may be made to related content of the image zooming method described in FIG. 2a, which are not described herein again.

As yet another embodiment of the present invention, the image zooming method further includes: disabling a zooming function of the terminal device when the displacement ΔS is greater than or equal to a maximum distance threshold Smax; or disabling a zooming function of the terminal device when the zoom ratio is greater than or equal to a maximum zoom ratio threshold.

It should be noted that when the displacement ΔS is greater than or equal to the maximum distance threshold Smax, including but not limited to disabling the zooming function of the terminal device, the image zooming method may further include: disabling a display function of the terminal device, or outputting, by the terminal device, prompt information, which is used to indicate to the holder of the terminal device that a zooming limit of the terminal device is reached, and the like. The maximum distance threshold Smax is a preset distance value, which is used to determine whether to disable the zooming function of the terminal device. Specifically, when the displacement ΔS is greater than or equal to the maximum distance threshold Smax, the display function of the terminal device is disabled. It should be noted that the experience of the user who uses the terminal device needs to be considered during presetting of the maximum distance threshold Smax, and the maximum distance threshold Smax may be 0.8 m, 1 m, or the like.

Similarly, when the zoom ratio is equal to the maximum zoom ratio threshold, including but not limited to disabling the zooming function of the terminal device, the image zooming method may further include: outputting, by the terminal device, prompt information, which is used to indicate to the holder of the terminal device that a zooming limit of the terminal device is reached, and the like. The maximum zoom ratio threshold is preset, and is used to determine whether to disable the zooming function of the terminal device. Specifically, when the zoom ratio is equal to the maximum zoom ratio threshold, the display function of the terminal device is disabled. It should be noted that the experience of the user who uses the terminal device needs to be considered during presetting of the maximum zoom ratio threshold, and the maximum zoom ratio threshold may be 1.5 times, 2 times, or the like.

When the terminal device is a portable mobile device, in a conventional zooming manner, a holder of the portable mobile device needs to fix the portable mobile device with one hand, and drag on a screen of the portable mobile device or click a key located on the portable mobile device with the other hand, so as to implement zooming of an image displayed on the portable mobile device. In this operation solution, two hands generally need to collaboratively work to successfully complete a zooming operation. By using the image zooming method provided in this embodiment of the present invention, the zooming of the image displayed on the terminal device can be implemented by only changing the distance between the terminal device and the holder of the terminal device. That is, the holder of the portable mobile device only needs to hold the portable mobile device with one hand to change a distance between the holder of the portable mobile device and the portable mobile device, even without carrying the portable mobile device. An image zooming function of the portable mobile device can be implemented by only adjusting a location of the holder of the portable mobile device to change the distance between the holder of the portable mobile device and the portable mobile device. Therefore, the image zooming method provided in this embodiment of the present invention is applied to a case in which only one hand of the holder of the portable mobile device is idle (for example, the holder of the portable mobile device carries goods with one hand when shopping, or pulls a suspension link with one hand when taking bus or subway), and a case in which the holder of the portable mobile device is a disabled person with only one hand being available for use.

It can be learned that according to the image zooming method provided in this embodiment of the present invention, an image zooming function of a terminal device can be implemented by only changing a distance between the terminal device and a holder of the terminal device. Specifically, when the distance between the terminal device and the holder of the terminal device is changed, displacement ΔS that the terminal device moves relative to the holder of the terminal device and time ΔT consumed when the terminal device moves the displacement ΔS are acquired, then a zoom ratio of an image is determined according to the displacement ΔS and the time ΔT, and then an image displayed on the terminal device is zoomed according to the zoom ratio. That is, according to the image zooming method provided in this embodiment of the present invention, the image displayed on the terminal device can be zoomed more conveniently.

Further, when the distance between the terminal device and the holder of the terminal device remains unchanged for a period longer than a preset time, the zoom ratio is maintained and the zooming is stopped, so that the holder of the mobile device may use an appropriate zoom ratio to browse the image displayed on a display screen of the terminal device.

### Embodiment 2

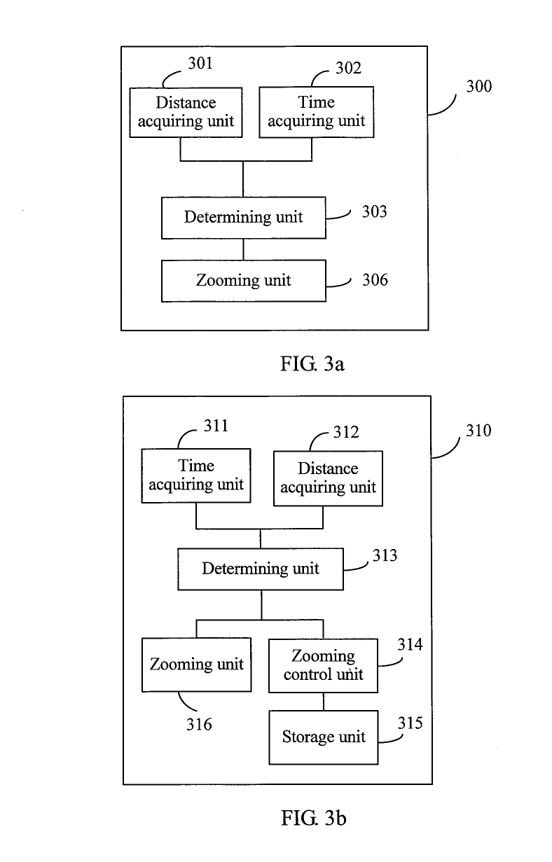

Referring to FIG. 3a, FIG. 3a is a schematic structural diagram of a terminal device 300 according to an embodiment of the present invention. The terminal device 300 provided in this embodiment of the present invention may be applied to the terminal device shown in FIG. 1. As shown in FIG. 3a, the terminal device 300 includes: a distance acquiring unit 301, a time acquiring unit 302, a determining unit 303, and a zooming unit 306.

The distance acquiring unit 301 is configured to acquire displacement ΔS that a terminal device moves relative to a holder of the terminal device.

It should be noted that the distance acquiring unit 301 is specifically configured to: acquire a distance S1 of the terminal device relative to the holder of the terminal device; move the terminal device and acquire a distance S2 of the terminal device relative to the holder of the terminal device, where the distance S2 is different from the distance S1; and acquire, according to the distance S1 and the distance S2, the displacement ΔS of the terminal device relative to the holder of the terminal device.

The distance acquiring unit 301 may correspond to a hardware device having a distance acquiring function, such as an infrared sensor.

Specifically, the distance acquiring unit 301 acquires a distance of the terminal device relative to the holder of the terminal device at a fixed time, such as 0.5 s. For example, at a moment T1, the distance acquiring unit 301 acquires the distance S1 of the terminal device relative to the holder of the terminal device. Correspondingly, at a moment T2, the distance acquiring unit 301 acquires the distance S2 of the terminal device relative to the holder of the terminal device. It should be noted that the distance S1 is different from the distance S2. Then the distance acquiring unit 301 acquires, through the distance S1 and the distance S2, the displacement ΔS of the terminal device relative to the holder of the terminal device.

It should be noted that the fixed time is preset. A smaller value that is set for the fixed time indicates higher sensitivity of zooming for the terminal device 300, and correspondingly, indicates a larger data volume that needs to be calculated, and a stronger processing capability required. Therefore, when the fixed time interval is preset, zooming sensitivity, a data calculation amount, and other related factors need to be comprehensively considered to set an appropriate time interval.

The time acquiring unit 302 is configured to acquire time ΔT consumed when the terminal device moves the displacement ΔS.

The time acquiring unit 302 is specifically configured to: record a moment T1 at which the terminal device acquires the distance S1; record a moment T2 at which the terminal device acquires the distance S2; and acquire, according to the moment T1 and the moment T2, the time ΔT consumed when the terminal device moves the displacement ΔS.

The determining unit 303 is connected to the distance acquiring unit 301 and the time acquiring unit 302, and is configured to determine a zoom ratio of the terminal device according to the displacement ΔS and the time ΔT.

The determining unit 303 is specifically configured to: calculate a movement speed of the terminal device according to the displacement ΔS and the time ΔT; and determine the zoom ratio of the terminal device according to the movement speed.

The zooming unit 306 is connected to the determining unit 303, and is configured to zoom, according to the zoom ratio, an image displayed on a display screen of the terminal device.

Referring to FIG. 3b, FIG. 3b is a schematic structural diagram of another terminal device 310 according to an embodiment of the present invention. In addition to the distance acquiring unit 311, the time acquiring unit 312, the determining unit 313, and the zooming unit 316, the terminal device 310 further includes a zooming control unit 314.

The distance acquiring unit 311, the time acquiring unit 312, the determining unit 313, and the zooming unit 316 in the terminal device 310 have the same functions as the distance acquiring unit 301, the time acquiring unit 302, the determining unit 303, and the zooming unit 306 in the terminal device 300. For details, reference is made to a function of each composition unit in the terminal device 300, which are not described herein again.

It should be noted that the zooming control unit 314 is configured to: when the displacement ΔS is zero and time of maintaining a state that the displacement ΔS is zero is greater than or equal to a time threshold, stop zooming in a case in which the zoom ratio is maintained.

That the displacement ΔS is zero means that a distance of the terminal device relative to the holder of the terminal device remains unchanged. The time threshold is a preset time interval, which is used to determine whether to stop zooming. Specifically, when the time of maintaining the state that the displacement ΔS is zero is greater than or equal to the time threshold, zooming is stopped in the case in which the zoom ratio is maintained. It should be noted that experience of a user who uses the terminal device needs to be considered during presetting of the time threshold, and the time threshold may be 1 s, 2 s, or the like.

Further, referring to FIG. 3b, the terminal device 310 further includes a storage unit 315, where the storage unit 315 is configured to store the zoom ratio when or after the zooming control unit 314 stops zooming in the case in which the zoom ratio is maintained.

It should be noted that the zooming control unit 314 is further configured to disable a zooming function of the terminal device when the displacement ΔS is greater than or equal to a maximum distance threshold Smax; or disable a zooming function of the terminal device when the zoom ratio is greater than or equal to a maximum zoom ratio threshold.

It should be noted that when the displacement ΔS is greater than or equal to the maximum distance threshold Smax, including but not limited to disabling the zooming function of the terminal device, the zooming control unit 314 may further disable a display function of the terminal device, and/or output prompt information, which is used to indicate to the holder of the terminal device that a zooming limit of the terminal device is reached, and the like. The maximum distance threshold Smax is a preset distance value, which is used to determine whether to disable the zooming function of the terminal device. Specifically, when the displacement ΔS is greater than or equal to the maximum distance threshold Smax, the display function of the terminal device is disabled. It should be noted that the experience of the user who uses the terminal device needs to be considered during presetting of the maximum distance threshold Smax, and the maximum distance threshold Smax may be 0.8 m, 1 m, or the like.

Similarly, when the zoom ratio is equal to the maximum zoom ratio threshold, including but not limited to disabling the zooming function of the terminal device, the zooming control unit 314 may further output prompt information, which is used to indicate to the holder of the terminal device that a zooming limit of the terminal device is reached, and the like. The maximum zoom ratio threshold is preset, and is used to determine whether to disable the zooming function of the terminal device. Specifically, when the zoom ratio is equal to the maximum zoom ratio threshold, the display function of the terminal device is disabled. It should be noted that the experience of the user who uses the terminal device needs to be considered during presetting of the maximum zoom ratio threshold, and the maximum zoom ratio threshold may be 1.5 times, 2 times, or the like.

When the terminal device is a portable mobile device, in a conventional zooming manner, a holder of the portable mobile device needs to fix the portable mobile device with one hand, and drag on a screen of the portable mobile device or press a key located on the portable mobile device with the other hand, so as to implement zooming of an image displayed on the portable mobile device. In this operation solution, two hands generally need to collaboratively work to successfully complete a zooming operation. By using the terminal device provided in this embodiment of the present invention, the zooming of the image displayed on the terminal device can be implemented by only changing the distance between the terminal device and the holder of the terminal device. That is, the holder of the portable mobile device only needs to hold the portable mobile device with one hand to change a distance between the holder of the portable mobile device and the portable mobile device, even without carrying the portable mobile device. An image zooming function of the portable mobile device can be implemented by only adjusting a location of the holder of the portable mobile device to change the distance between the holder of the portable mobile device and the portable mobile device. Therefore, the terminal device provided in this embodiment of the present invention is applied to a case in which only one hand of the holder of the portable mobile device is idle (for example, the holder of the portable mobile device carries goods with one hand when shopping, or pulls a suspension link with one hand when taking bus or subway), and a case in which the holder of the portable mobile device is a disabled person with only one hand being available for use.

It can be learned that when the terminal device provided in this embodiment of the present invention is used to perform image zooming, an image zooming function of the terminal device can be implemented by only changing a distance between the terminal device and a holder of the terminal device. Specifically, when the distance between the terminal device and the holder of the terminal device is changed, displacement ΔS that the terminal device moves relative to the holder of the terminal device and time ΔT consumed when the terminal device moves the displacement ΔS are acquired, then a zoom ratio of an image is determined according to the displacement ΔS and the time ΔT, and then an image displayed on the terminal device is zoomed according to the zoom ratio. By using the terminal device provided in this embodiment of the present invention, image zooming is performed more conveniently with higher flexibility. That is, according to the image zooming method provided in this embodiment of Present invention, the image displayed on the terminal device can be zoomed more conveniently.

Further, when the distance between the terminal device and the holder of the terminal device remains unchanged for a period longer than a preset time, the terminal device provided in this embodiment of the present invention may further maintain the zoom ratio and stop zooming, so that the holder of the mobile device may use an appropriate zoom ratio to browse the image displayed on a display screen of the terminal device.

### Embodiment 3

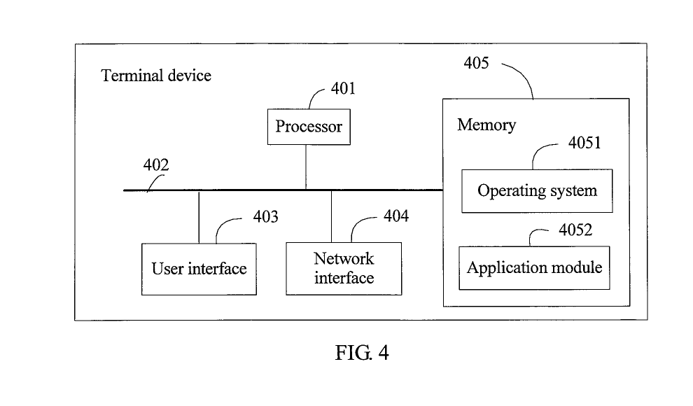

Correspondingly, this embodiment of the present invention further provides a terminal device. As shown in FIG. 4, the terminal device may include at least one processor 401 such as a CPU, at least one network interface 404 such as a physical network interface card, or another user interface 403, a memory 405, a display 406, and at least one communications bus 402.

The communications bus 402 is configured to implement a connection and communication between these components.

The network interface 404 is configured to implement a connection and communication between the terminal device and a network, for example, the network interface 404 may be configured to connect devices such as a physical network interface card and/or a physical switch.

Optionally, the user interface 403 may include a display, a keyboard or another clicking device, such as a mouse, a trackball (trackball), a touch panel, or a touch display screen.

The memory 405 may include a high-speed random access memory (RAM, Random Access Memory), and may further include a non-volatile memory (non-volatile memory), such as at least one magnetic disk memory. Optionally, the memory 405 may further include at least one storage apparatus located far from the foregoing processor 401.

In some implementation manners, the memory 405 stores following elements: an executable module or a data structure, or their subsets, or their extended sets:

an operating system 4051, including various system programs, configured to implement various basic services and process hardware-based tasks; and

an application module 4052, including various application programs, configured to implement various application services.

In this embodiment of the present invention, by invoking an operation instruction (the operation instruction may be stored in an operating system) stored in the memory 405, the processor 401 is configured to: acquire displacement ΔS that a terminal device moves relative to a holder of the terminal device; acquire time ΔT consumed when the terminal device moves the displacement ΔS; determine a zoom ratio of the terminal device according to the displacement ΔS and the time ΔT; and zoom, according to the zoom ratio, an image displayed on a display screen of the terminal device.

The processor 401 is specifically configured to: acquire a distance S1 of the terminal device relative to the holder of the terminal device; acquire a distance S2 of the terminal device relative to the holder of the terminal device, where the distance S2 is different from the distance S1; and acquire, according to the distance S1 and the distance S2, the displacement ΔS of the terminal device relative to the holder of the terminal device; and/or

the processor 401 is specifically configured to: record a moment T1 at which the terminal device acquires the distance S1; record a moment T2 at which the terminal device acquires the distance S2; and acquire, according to the moment T1 and the moment T2, the time ΔT consumed when the terminal device moves the displacement ΔS.

As another embodiment of the present invention, the processor 401 is further configured to: when the displacement ΔS is zero and time of maintaining a state that the displacement ΔS is zero is greater than or equal to a time threshold, stop zooming in a case in which the zoom ratio is maintained. Preferably, the processor 401 is further configured to store the zoom ratio when or after zooming is stopped in the case in which the zoom ratio is maintained.

As yet another embodiment of the present invention, the processor 401 is further configured to disable a zooming function of the terminal device when the displacement ΔS is greater than or equal to a maximum distance threshold Smax; or disable a zooming function of the terminal device when the zoom ratio is equal to a maximum zoom ratio threshold.

It can be learned that when the terminal device provided in this embodiment of the present invention is used to perform image zooming, an image zooming function of the terminal device can be implemented by only changing a distance between the terminal device and a holder of the terminal device. Specifically, when the distance between the terminal device and the holder of the terminal device is changed, displacement ΔS that the terminal device moves relative to the holder of the terminal device and time ΔT consumed when the terminal device moves the displacement ΔS are acquired, then a zoom ratio of an image is determined according to the displacement ΔS and the time ΔT, and then an image displayed on the terminal device is zoomed according to the zoom ratio. By using the terminal device provided in this embodiment of the present invention, an image zooming operation is performed more conveniently, and it is easier to implement the image zooming function of the terminal device.

Further, when the distance between the terminal device and the holder of the terminal device remains unchanged for a period longer than a preset time, the terminal device provided in this embodiment of the present invention may further maintain the zoom ratio and stop zooming, so that the holder of the mobile device may use an appropriate zoom ratio to browse the image displayed on a display screen of the terminal device.

With descriptions of the foregoing embodiments, a person skilled in the art may clearly understand that the present invention may be implemented by hardware, firmware or a combination thereof. When the present invention is implemented by software, the foregoing functions may be stored in a computer-readable medium or transmitted as one or more instructions or code in the computer-readable medium. The computer-readable medium includes a computer storage medium and a communications medium, where the communications medium includes any medium that enables a computer program to be transmitted from one place to another. The storage medium may be any available medium accessible to a computer. The following provides an example but does not impose a limitation: The computer-readable medium may include a RAM, a ROM, an EEPROM, a CD-ROM or other optical disc storage, or a disk storage medium or another magnetic storage device, or any other medium that can carry or store expected program code in a form of an instruction or a data structure and can be accessed by a computer. In addition, any connection may be appropriately defined as a computer-readable medium. For example, if software is transmitted from a website, a server or another remote source by using a coaxial cable, an optical fiber/cable, a twisted pair, a digital subscriber line (DSL) or wireless technologies such as infrared ray, radio and microwave, the coaxial cable, optical fiber/cable, twisted pair, DSL or wireless technologies such as infrared ray, radio and microwave are included in definition of a medium to which they belong. For example, a disk (Disk) and disc (disc) used by the present invention include a compact disc (CD), a laser disc, an optical disc, a digital versatile disc (DVD), a floppy disk and a Blu-ray disc, where the disk generally copies data by a magnetic means, and the disc copies data optically by a laser means. The foregoing combination should also be included in the protection scope of the computer-readable medium.

A person of ordinary skill in the art may understand that all or some of the steps of the methods in the embodiments may be implemented by a program instructing relevant hardware (for example, a processor connected to a memory). The program may be stored in a computer-readable storage medium. The storage medium may include: a read-only memory, a random-access memory, a magnetic disk, or an optical disc.

It should be noted that the embodiments in this specification are all described in a progressive manner, for same or similar parts in the embodiments, reference may be made to these embodiments, and each embodiment focuses on a difference from other embodiments. Especially, an apparatus embodiment is basically similar to a method embodiment, and therefore is described briefly; for execution processes of specific functions of each unit, reference may be made to partial descriptions in the method embodiment. The described apparatus embodiment is merely exemplary. The units described as separate parts may or may not be physically separate, and parts displayed as units may or may not be physical units, may be located in one position, or maybe distributed on a plurality of network units. Some or all of the modules may be selected according to actual requirements to achieve the objectives of the solutions of the embodiments. A person of ordinary skill in the art may understand and implement the embodiments of the present invention without creative efforts.

In summary, what is described above is merely exemplary embodiments of the technical solutions of the present invention, but is not intended to limit the protection scope of the present invention. Any modification, equivalent replacement, or improvement made without departing from the spirit and principle of the present invention shall fall within the protection scope of the present invention.

What is claimed is:

1. An image zooming method, the method comprising:
acquiring a displacement ΔS that a terminal device moves relative to a holder of the terminal device;
acquiring a time ΔT consumed when the terminal device moves the displacement ΔS;
determining a zoom ratio of the terminal device according to the displacement ΔS and the time ΔT; and
zooming, according to the zoom ratio, an image displayed on a display screen of the terminal device.

2. The image zooming method according to claim 1, wherein acquiring the displacement ΔS that the terminal device moves relative to the holder of the terminal device comprises:
acquiring a distance S1 of the terminal device relative to the holder of the terminal device;
acquiring a distance S2 of the terminal device relative to the holder of the terminal device, wherein the distance S2 is different from the distance S1; and
acquiring, according to the distance S1 and the distance S2, the displacement ΔS of the terminal device relative to the holder of the terminal device.

3. The image zooming method according to claim 2, wherein acquiring the time ΔT consumed when the terminal device moves the displacement ΔS comprises:
recording a moment T1 at which the terminal device acquires the distance S1;
recording a moment T2 at which the terminal device acquires the distance S2; and
acquiring, according to the moment T1 and the moment T2, the time ΔT consumed when the terminal device moves the displacement ΔS.

4. The image zooming method according to claim 1, wherein determining the zoom ratio of the terminal device according to the displacement ΔS and the time ΔT comprises:
calculating a movement speed of the terminal device according to the displacement ΔS and the time ΔT; and
determining the zoom ratio of the terminal device according to the movement speed.

5. The image zooming method according to claim 1, wherein the method further comprises:
when the displacement ΔS is zero and time during which the displacement ΔS remains zero is greater than or equal to a time threshold, stopping zooming while the zoom ratio is maintained.

6. The image zooming method according to claim 5, further comprising:
in response to stopping zooming while the zoom ratio is maintained, storing the zoom ratio.

7. The image zooming method according to claim 1, wherein the method further comprises:
disabling a zooming function of the terminal device when the displacement ΔS is greater than or equal to a maximum distance threshold Smax; or
disabling a zooming function of the terminal device when the zoom ratio is greater than or equal to a maximum zoom ratio threshold.

8. A terminal device, wherein the terminal device comprises:
a distance acquiring unit, configured to acquire a displacement ΔS that a terminal device moves relative to a holder of the terminal device;
a time acquiring unit, configured to acquire a time ΔT consumed when the terminal device moves the displacement ΔS;
a determining unit, connected to the distance acquiring unit and the time acquiring unit, and configured to determine a zoom ratio of the terminal device according to the displacement ΔS and the time ΔT; and
a zooming unit, connected to the determining unit, and configured to zoom, according to the zoom ratio, an image displayed on a display screen of the terminal device.

9. The terminal device according to claim 8, wherein:
the distance acquiring unit is configured to:
acquire a distance S1 of the terminal device relative to the holder of the terminal device;
move the terminal device and acquire a distance S2 of the terminal device relative to the holder of the terminal device, wherein the distance S2 is different from the distance S1; and
acquire, according to the distance S1 and the distance S2, the displacement ΔS of the terminal device relative to the holder of the terminal device.

10. The terminal device according to claim 9, wherein:
the time acquiring unit is configured to:
record a moment T1 at which the terminal device acquires the distance S1;
record a moment T2 at which the terminal device acquires the distance S2; and
acquire, according to the moment T1 and the moment T2, the time ΔT consumed when the terminal device moves the displacement ΔS.

11. The terminal device according to claim 8, wherein
the determining unit is configured to:
calculate a movement speed of the terminal device according to the displacement ΔS and the time ΔT; and
determine the zoom ratio of the terminal device according to the movement speed.

12. The terminal device according to claim 8, further comprising:
a zooming control unit configured to:
when the displacement ΔS is zero and time during which the displacement ΔS remains zero is greater than or equal to a time threshold, stop zooming while the zoom ratio is maintained.

13. The terminal device according to claim 12, further comprising:
a storage unit configured to store the zoom ratio in response to the zooming control unit stopping zooming while the zoom ratio is maintained.

14. The terminal device according to claim 12, wherein:
the zooming control unit is further configured to:
disable a zooming function of the terminal device when the displacement ΔS is greater than or equal to a maximum distance threshold Smax; or
disable a zooming function of the terminal device when the zoom ratio is greater than or equal to a maximum zoom ratio threshold.
